(19) United States
(12) Patent Application Publication
(10) Pub. No.: US 2018/0051178 A1
(43) Pub. Date: Feb. 22, 2018

(54) HYDROPHILIC COMPOSITION WITH CONDENSATION CATALYST

(71) Applicant: Hamilton Sundstrand Corporation, Windsor Locks, CT (US)

(72) Inventors: John W. Steele, New Hartford, CT (US); Barbara M. Peyton, Windsor, CT (US); Tony Rector, East Granby, CT (US)

(21) Appl. No.: 15/242,841

(22) Filed: Aug. 22, 2016

(51) Int. Cl. C09D 5/14; C09D 5/00; A01N 59/22; A01N 59/16; A01N 59/18; A01N 59/12; C09D 7/12; F28F 17/00

(52) U.S. Cl. CPC C09D 5/14; C09D 5/00; A01N 59/22; A01N 59/16; F28F 2245/02; A01N 59/12; C09D 7/1216; F28F 17/005; A01N 59/18

(57) ABSTRACT

A hydrophilic composition includes about 10 to about 30 parts by weight of an adhesive agent, about 10 to about 20 parts by weight of an inorganic compound, about 3 to about 10 parts by weight of an insolubilizer, about 0.3 to about 1.5 parts by weight of an antimicrobial agent, and about 1 to about 40 parts by weight of a condensation catalyst.

### BACKGROUND

This disclosure relates to inorganic hydrophilic coatings. Condensing heat exchangers, such as those used in micro- or zero-gravity applications, may utilize hydrophilic and antimicrobial coating systems to remove condensed water for subsequent collection. In particular, such coating systems inhibit microbial proliferation and promote wetting and wicking of water, thereby inducing condensate in the condenser to form a thin spreading film in the coating that can readily be collected. This thin film is collected through “slurper” holes into a gas-liquid phase separator which keeps water droplets from being entrapped in the gaseous stream from which it was removed.

### SUMMARY

A hydrophilic composition according to an example of the present disclosure includes about 10 to about 30 parts by weight of an adhesive agent, about 10 to about 20 parts by weight of an inorganic compound, about 3 to about 10 parts by weight of an insolubilizer, about 0.3 to about 1.5 parts by weight of an antimicrobial agent, and about 1 to about 40 parts by weight of a condensation catalyst.

In a further embodiment of any of the foregoing embodiments, the condensation catalyst is a catalyst with respect to condensation of silane diols.

In a further embodiment of any of the foregoing embodiments, the condensation catalyst is a catalyst with respect to condensation of dimethylsilanediol.

In a further embodiment of any of the foregoing embodiments, the condensation catalyst is about 1.5 to about 14 parts by weight.

In a further embodiment of any of the foregoing embodiments, the condensation catalyst is about 7 to about 10 parts by weight.

In a further embodiment of any of the foregoing embodiments, the condensation catalyst is a base-substituted zeolite.

In a further embodiment of any of the foregoing embodiments, the condensation is about 1.5 to about 14 parts by weight.

In a further embodiment of any of the foregoing embodiments, the condensation catalyst is ammonium-substituted zeolite.

In a further embodiment of any of the foregoing embodiments, the condensation catalyst is about 1.5 to about 14 parts by weight.

In a further embodiment of any of the foregoing embodiments, the adhesive agent is selected from potassium silicate, lead borosilicate glass frit, and mixtures thereof. The inorganic compound is selected from the group consisting of silica, calcium silicate, and mixtures thereof. The insolubilizer is selected from silicofluorides, inorganic oxides, and mixtures thereof. The antimicrobial agent includes at least one of arsenic, iodine, iron, mercury, silver, and tin.

An article according to an example of the present disclosure includes a substrate, and a hydrophilic coating on the substrate. The hydrophilic coating is composed of about 10 to about 30 parts by weight of an adhesive agent, about 10 to about 20 parts by weight of an inorganic compound, about 3 to about 10 parts by weight of an insolubilizer, about 0.3 to about 1.5 parts by weight of an antimicrobial agent, and about 1 to about 40 parts by weight of a condensation catalyst.

In a further embodiment of any of the foregoing embodiments, the substrate is in a condensing heat exchanger.

In a further embodiment of any of the foregoing embodiments, the condensation catalyst is a catalyst with respect to condensation of silane diols.

In a further embodiment of any of the foregoing embodiments, the condensation catalyst is about 1.5 to about 14 parts by weight.

In a further embodiment of any of the foregoing embodiments, the condensation catalyst is a base-substituted zeolite.

In a further embodiment of any of the foregoing embodiments, the adhesive agent is selected from potassium silicate, lead borosilicate glass frit, and mixtures thereof. The inorganic compound is selected from silica, calcium silicate, and mixtures thereof. The insolubilizer is selected from silicofluorides, inorganic oxides, and mixtures thereof. The antimicrobial agent includes at least one of arsenic, iodine, iron, mercury, silver, and tin.

A method according to an example of the present disclosure includes forming a hydrophilic coating composed of about 10 to about 30 parts by weight of an adhesive agent, about 10 to about 20 parts by weight of an inorganic compound, about 3 to about 10 parts by weight of an insolubilizer, about 0.3 to about 1.5 parts by weight of an antimicrobial agent, and about 1 to about 40 parts by weight of a condensation catalyst.

In a further embodiment of any of the foregoing embodiments, the forming includes depositing a slurry onto a substrate. The slurry includes the adhesive agent, the inorganic compound, the insolubilizer, the antimicrobial agent, and the condensation catalyst mixed with a solvent, and drying the slurry to remove the solvent such that the hydrophilic coating remains on the substrate.

In a further embodiment of any of the foregoing embodiments, the forming includes infiltrating a pre-existing coating with the condensation catalyst, the pre-existing coating having the adhesive agent, the inorganic compound, the insolubilizer, and the antimicrobial agent.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example article that has a hydrophilic coating with a condensation catalyst.

FIG. 2 illustrates a cross-section through a portion of the article of FIG. 1.

FIG. 3 illustrates an example method of forming a hydrophilic coating.

### DETAILED DESCRIPTION

Self-contained habitable systems, such as the International Space Station (ISS), utilize a Water Processor Assembly (WPA) to treat and clean water for crew consumption. Prior to consumption the treated water is tested for quality, including total organic carbon. A high total organic carbon reading may indicate that filters in the WPA need to be changed or that there is an issue in the operation of the WPA.

A portion of the water treated in the WPA comes from the Common Cabin Air Assembly (CCAA) of the ISS. The CCAA treats and conditions air in the ISS. This treatment and conditioning includes temperature adjustment and moisture removal in one or more condensing heat exchangers. Such condensing heat exchangers may include inorganic hydrophilic coatings that facilitate water collection by condensing water from the air and wicking the water to a collector. The water from the collector can then be treated in the WPA.

The water from the WPA can include silane diols, such as dimethylsilanediol (DMSD). The DMSD molecule is depicted below. DMSD is particularly concerning because DMSD can cause elevated measurements of total organic carbon, yet DMSD is not an indicator that a Multifiltration Bed (which contain ion exchange resins and organic sorbants) in the WPA needs to be changed and does not prevent crew consumption. Thus, when there is an elevated total organic carbon reading due to DMSD (which the crew would not know was due to DMSD), the Multifiltration Beds may be unnecessarily changed, water consumption may be unnecessarily limited, and expensive ground-based testing may be required to confirm that the source of the elevated reading is DMSD.

Dimethylsilanediol:

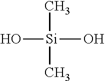

Silane diols evolve from hydrolysis of siloxanes, such as silicone from the air in the ISS. When the air is treated in the CCAA the siloxanes deposit on the hydrophilic coating of the condensing heat exchanger. While siloxanes are generally inert/unreactive, silicates in the hydrophilic coating hydrolyze the siloxane under wet and dry conditions. This process is accelerated under dry conditions. The silane diols are then later picked up by condensed water in the heat exchanger. Filter beds in the WPA are not capable of effectively removing the silane diols. In this regard, disclosed herein is a hydrophilic composition that can be used in such condensing heat exchangers to suppress silane diol formation. As will be appreciated, although one example implementation is in a condensing heat exchanger in the ISS, this disclosure may also benefit other applications where silane diols are undesired.

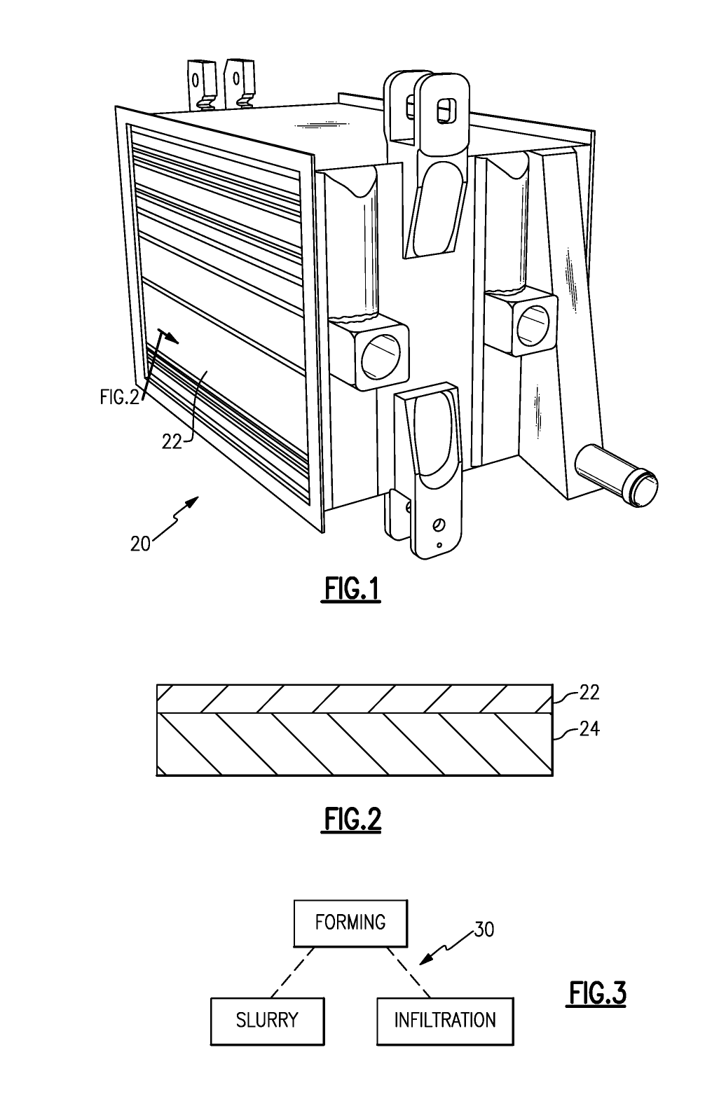

FIG. 1 schematically illustrates an example article 20. In this example, the article 20 is a condensing heat exchanger that includes a hydrophilic coating 22. For instance, the hydrophilic coating 22 may be on slurper bars of the heat exchanger in order to wick condensed water. The location of the hydrophilic coating 22 is not limited to slurper bars and may be on any portion or any heat transfer surface of the condensing heat exchanger that is to be in contact with condensed water.

FIG. 2 illustrates a sectioned view through a representative portion of one of the slurper bars of the article 20. In this example, the hydrophilic coating 22 is disposed on a substrate 24, which may be a metal alloy wall, for example. The hydrophilic coating 22 is composed of: about 10 to about 30 parts by weight of an adhesive agent, about 10 to about 20 parts by weight of an inorganic compound, about 3 to about 10 parts by weight of an insolubilizer, about 0.3 to about 1.5 parts by weight of an antimicrobial agent, and about 1 to about 40 parts by weight of a condensation catalyst. In further examples, each composition example herein may include impurities. In additional examples, each composition example herein may include only the listed constituents or only the listed constituents and impurities.

The adhesive agent serves as a binder to provide the hydrophilic coating 22 with structural integrity and limit flaking and cracking of the coating. For example, the adhesive agent may be selected from potassium silicate, lead borosilicate glass frit, and mixtures thereof. In a further example, the adhesive agent is potassium silicate and is present in the hydrophilic coating 22 in an amount of about 10 parts by weight to about 30 parts by weight. In a further example, the amount is about 25.0 to about 25.4 parts by weight.

The inorganic compound facilitates wetting between water and the hydrophilic coating 22, i.e., the inorganic compound promotes hydrophilic character. For example, the inorganic compound is selected from silica, calcium silicate, and mixtures thereof. In a further example, the inorganic compound is silica flour and is present in about 12 to about 16 parts by weight. In a further example, the silica flour is present in about 14.0 to about 14.2 parts by weight.

The adhesive agent is generally water soluble. To facilitate coating preparation the insolubilizer is used in the composition of the hydrophilic coating 22. The insolubilizer is selected from silicofluorides, inorganic oxides, and mixtures thereof. The silicofluorides may be silicofluorides of sodium, potassium, barium, manganese, or mixtures of these. The inorganic oxides may include zinc oxide or may be pure zinc oxide. In a further example, zinc oxide or other insolubilizer is present in the hydrophilic coating 22 in an amount of about 4 to about 7 parts by weight. In one additional example, zinc oxide or other insolubilizer is present in the hydrophilic coating 22 in an amount of about 5.4 to about 5.6 parts by weight.

The antimicrobial agent provides the hydrophilic coating 22 with biocidal characteristics to prevent microbial proliferation. For example, the antimicrobial agent includes at least one of arsenic, iodine, iron, mercury, silver, and tin, which may be initially be salts during preparation of the hydrophilic coating 22. In a further example, the antimicrobial agent is silver oxide. In a further example, the silver oxide or other antimicrobial agent is present in the hydrophilic coating 22 in an amount of about 0.8 to about 1.2 parts by weight. In one additional example, the amount of silver oxide or other antimicrobial agent is about 0.9 to about 1.1 parts by weight.

The condensation catalyst is a catalyst with regard to promotion of catalytic condensation of silane diols, such as DMSD. An example of such a condensation reaction is shown below in Reaction 1. While silicates in the composition of the hydrophilic coating 22 may hydrolyze siloxanes to produce silane diols, the condensation catalyst in the hydrophilic coating 22 counteracts such formation of silane diols by converting silane diols to siloxanes. As an example, the condensation catalyst is capable of converting low molecular weight silane diols into silanes, such as silane polymers of 10⁵ molecular weight. The amount of silane diol available to be picked up by condensed water is thus reduced, thereby reducing the potential for elevated readings of total organic carbon due to silane diols, such as DMSD.

[—SiOH]ₙ+[—SiOH]ₙ---------→[Si—O—Si]ₙ+H₂O REACTION 1

In a further example, the condensation catalyst is a base-substituted zeolite. An example base-substituted zeolite is an ammonium-substituted zeolite. In one further example, the zeolite is a silica (SiO₂)-alumina (Al₂O₃) composition and has a mole ratio of silica/alumina of about 23. The condensation catalyst, and in particular the ammonium-substituted zeolite, has limited or no effect on other properties of interest of the hydrophilic coating 22, such as adhesion, cohesion, wettability, and antimicrobial properties.

The amount of condensation catalyst in the hydrophilic coating is about 1 to about 40 parts by weight. The amount selected for use will typically depend on the degree of conversion desired for condensing silane diols to siloxanes. Thus, for lower desired levels of silane diols, higher amount of the condensation catalyst may generally be used, and vice versa. In one example, the condensation catalyst is ammonium-substituted zeolite or other condensation catalyst and is about 1.5 to about 14 parts by weight in the hydrophilic coating 22. In one further example, the ammonium-substituted zeolite or other condensation catalyst is about 7 to about 11 parts by weight in the hydrophilic coating 22. In one additional example, the ammonium-substituted zeolite or other condensation catalyst is about 8.9 to about 9.3 parts by weight. As an example, the rate of formation of silane diol, such as DMSD, may be reduced by approximately 25% using the condensation catalyst. Of course, the actual reduction may vary with the amount of condensation catalyst used and the particular composition of the hydrophilic coating 22.

The examples described above may be representative of the hydrophilic coating 22 applied as a new coating in the article 20. For instance, FIG. 3 generally illustrates a method 30 of forming the hydrophilic coating 22 described herein. The hydrophilic coating 22 may be formed, for example, using a slurry technique or an infiltration technique.

In the slurry technique, the constituents of the composition of the hydrophilic coating 22, such as powders of the constituents, can be mixed in a slurry with a solvent, such as water. The water may be present in an amount of about 30 to about 70 parts by weight in the slurry. The slurry can then be applied to the article 20, or particular desired locations of the article 20. The method of application is not particularly limited and may include dipping, spraying, and/or painting the slurry onto a surface of the article 20. The applied slurry may then be dried to remove the water, either naturally or in an elevated temperature environment. One or more of the constituents may also cure in conjunction with water removal. Once the water is removed, the constituents remain on the article as the hydrophilic coating 22. The slurry application and drying may be repeated to produce thicker coatings. Generally, the drying/curing temperature is not so high as to induce sintering of the constituents. Typically, the drying/curing temperature (or temperatures if sequential drying/curing is used) is about 260° C. or less.

The infiltration technique could also be employed to produce a new version of the hydrophilic coating 22. For instance, an initial coating that has the adhesive agent, the inorganic compound, the insolubilizer, and the antimicrobial agent can be formed via the slurry technique, but without the condensation catalyst. The condensation catalyst is then infiltrated into the initial coating as described above for the pre-existing coating.

The composition of a “refurbished” hydrophilic coating 22 may differ somewhat from the hydrophilic coating 22 if newly applied. If newly applied, the composition may be adjusted for enhanced performance with respect to adhesion, cohesion, wettability, etc. If used as a “refurbished” hydrophilic coating 22, the composition is subject to the composition of the pre-existing coating. In one example, such a “refurbished” hydrophilic coating 22 has a composition of about 15 to about 25 parts by weight of the adhesive agent, about 13.5 to about 17.5 parts by weight of the inorganic compound, about 4 to about 8 parts by weight of the insolubilizer, and about 1 to about 40 parts by weight of the condensation catalyst. In a further example, there is about 1.5 to about 14.0 parts by weight of the condensation catalyst. In one additional example the “refurbished” hydrophilic coating 22 has a composition of about 19.2 to about 19.6 parts by weight of the adhesive agent (potassium silicate), about 15.4 to about 15.6 of the inorganic compound (silica flour), about 5.9 to about 6.1 of the insolubilizer (zinc oxide), about 1.3 to about 1.5 of the antimicrobial agent (silver oxide), and about 1.5 to about 14.0 parts by weight of the condensation catalyst (ammonium-substituted zeolite).

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A hydrophilic composition comprising:
about 10 to about 30 parts by weight of an adhesive agent;
about 10 to about 20 parts by weight of an inorganic compound;
about 3 to about 10 parts by weight of an insolubilizer;
about 0.3 to about 1.5 parts by weight of an antimicrobial agent; and
about 1 to about 40 parts by weight of a condensation catalyst.

2. The hydrophilic composition as recited in claim 1, wherein the condensation catalyst is a catalyst with respect to condensation of silane diols.

3. The hydrophilic composition as recited in claim 2, wherein the condensation catalyst is a catalyst with respect to condensation of dimethylsilanediol.

4. The hydrophilic composition as recited in claim 2, wherein the condensation catalyst is about 1.5 to about 14 parts by weight.

5. The hydrophilic composition as recited in claim 2, wherein the condensation catalyst is about 7 to about 10 parts by weight.

6. The hydrophilic composition as recited in claim 1, wherein the condensation catalyst is a base-substituted zeolite.

7. The hydrophilic composition as recited in claim 6, wherein the condensation is about 1.5 to about 14 parts by weight.

8. The hydrophilic composition as recited in claim 1, wherein the condensation catalyst is ammonium-substituted zeolite.

9. The hydrophilic composition as recited in claim 8, wherein the condensation catalyst is about 1.5 to about 14 parts by weight.

10. The hydrophilic composition as recited in claim 1, wherein the adhesive agent is selected from the group consisting of potassium silicate, lead borosilicate glass frit, and mixtures thereof, the inorganic compound is selected from the group consisting of silica, calcium silicate, and mixtures thereof, the insolubilizer is selected from the group consisting of silicofluorides, inorganic oxides, and mixtures thereof, and the antimicrobial agent includes at least one of arsenic, iodine, iron, mercury, silver, and tin.

11. An article comprising:
a substrate; and
a hydrophilic coating on the substrate, the hydrophilic coating composed of:
about 10 to about 30 parts by weight of an adhesive agent;
about 10 to about 20 parts by weight of an inorganic compound;
about 3 to about 10 parts by weight of an insolubilizer;
about 0.3 to about 1.5 parts by weight of an antimicrobial agent; and
about 1 to about 40 parts by weight of a condensation catalyst.

12. The article as recited in claim 11, wherein the substrate is in a condensing heat exchanger.

13. The article as recited in claim 11, wherein the condensation catalyst is a catalyst with respect to condensation of silane diols.

14. The article as recited in claim 13, wherein the condensation catalyst is about 1.5 to about 14 parts by weight.

15. The article as recited in claim 14, wherein the condensation catalyst is a base-substituted zeolite.

16. The article as recited in claim 15, wherein the adhesive agent is selected from the group consisting of potassium silicate, lead borosilicate glass frit, and mixtures thereof, the inorganic compound is selected from the group consisting of silica, calcium silicate, and mixtures thereof, the insolubilizer is selected from the group consisting of silicofluorides, inorganic oxides, and mixtures thereof, and the antimicrobial agent includes at least one of arsenic, iodine, iron, mercury, silver, and tin.

17. A method comprising:
forming a hydrophilic coating composed of:
about 10 to about 30 parts by weight of an adhesive agent;
about 10 to about 20 parts by weight of an inorganic compound;
about 3 to about 10 parts by weight of an insolubilizer;
about 0.3 to about 1.5 parts by weight of an antimicrobial agent; and
about 1 to about 40 parts by weight of a condensation catalyst.

18. The method as recited in claim 17, wherein the forming includes depositing a slurry onto a substrate, the slurry including the adhesive agent, the inorganic compound, the insolubilizer, the antimicrobial agent, and the condensation catalyst mixed with a solvent, and drying the slurry to remove the solvent such that the hydrophilic coating remains on the substrate.

19. The method as recited in claim 17, wherein the forming includes infiltrating a pre-existing coating with the condensation catalyst, the pre-existing coating having the adhesive agent, the inorganic compound, the insolubilizer, and the antimicrobial agent.
